(19) United States
(12) Patent Application Publication
(10) Pub. No.: US 2026/0057385 A1
(43) Pub. Date: Feb. 26, 2026

(54) Electronic Devices, Systems, and Corresponding Methods to Prevent Fraud During Cardless Cash Withdrawals

(71) Applicant: Motorola Mobility LLC, Chicago, IL (US)

(72) Inventors: Krishnan Raghavan, Bangalore (IN); Nakul Patel, Nagpur (IN); Vinay Basavanna, Bangalore (IN)

(21) Appl. No.: 18/812,836

(22) Filed: Aug. 22, 2024

(51) Int. Cl. G06Q 20/40; G06Q 20/32

(52) U.S. Cl. CPC G06Q 20/4015; G06Q 20/3276; G06Q 20/4016

(57) ABSTRACT

Electronic devices, systems, and methods described herein prevent fraud during cardless cash withdrawals by employing location-based verification. The method involves obtaining identifying information about another electronic device from an object within the environment of the electronic device, determining the location of the electronic device, and verifying if the location is proximately located with the other electronic device. If the locations do not sufficiently match, a prompt with a fraud warning can be presented on the user interface. The system ensures that the transaction is initiated with the correct device, reducing the risk of fraud due to device manipulation by fraudsters.

### BACKGROUND

### Technical Field

This disclosure relates generally to electronic devices, and more particularly to electronic devices having user interfaces.

### Background Art

Portable electronic devices, such as smartphones and tablet computers, have become the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card.

As these devices begin to use more and more financial information, scammers and other miscreants have begun to try and exploit security gaps that may exist when these devices are used in financial transactions. It would be advantageous to have improved devices and systems to prevent situations such as this from occurring.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory method in accordance with one or more embodiments of the disclosure.

FIG. 2 illustrates one explanatory electronic device in accordance with one or more embodiments of the disclosure.

FIG. 3 illustrates another explanatory method in accordance with one or more embodiments of the disclosure.

FIG. 4 illustrates one explanatory electronic device presenting one explanatory prompt in accordance with one or more embodiments of the disclosure.

FIG. 5 illustrates one or more method steps in accordance with one or more embodiments of the disclosure.

FIG. 6 illustrates another explanatory method in accordance with one or more embodiments of the disclosure.

FIG. 7 illustrates various embodiments of the disclosure.

FIG. 8 illustrates a prior art method.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to determining, with one or more processors of an electronic device from identifying information about another electronic device, one example of which is an automated teller machine, whether the location of the electronic device is proximately located with the another electronic device and, where the one or more processors fail to determine that the another electronic device is proximately located with the electronic device, presenting, by the one or more processors on a user interface of the electronic device, a prompt comprising a fraud warning. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of presenting a prompt on a user interface indicating that a financial transaction, initiated with a first remote electronic device situated beyond a predefined threshold from a location determined by a location detector but identified by information the one or more sensors obtained from a second remote electronic device situated within an environment of the electronic device, should be aborted as described herein. The non-processor circuits may include, but are not limited to, a radio receiver, a radio transmitter, signal drivers, clock circuits, power source circuits, and user input devices.

As such, these functions may be interpreted as steps of a method to perform scanning, with an image capture device, a quick reference (QR) code from an automated teller machine (ATM) situated within an environment of the electronic device, determining, with one or more processors, whether the QR code identifies an ATM location that is proximately located with a location of the electronic device determined by a location detector carried by the electronic device, and where the one or more processors fail to determine that the ATM location is proximately located with the location of the electronic device determined by the location detector, presenting, by the one or more processors, a prompt on a user interface of the electronic device allowing a financial transaction initiated by the one or more processors with the ATM to be aborted.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide electronic devices, systems, and corresponding methods for preventing fraud during cardless cash withdrawals by employing location-based verification. In one or more embodiments, this approach involves capturing the user's location when they scan the QR code on the ATM and cross-referencing it with the ATM's designated location. If there is a discrepancy between the user's location and the ATM's location, the system triggers an alert, allowing the user to abort the transaction. Embodiments of the disclosure effectively mitigate the risk of manipulated QR codes and ensures that the cash withdrawal occurs at the intended ATM, thereby providing an added layer of security that is not present in existing cardless withdrawal systems.

In one or more embodiments, a method in an electronic device comprises obtaining, with a communication device or one or more sensors of the electronic device, identifying information about another electronic device from an object situated within an environment of the electronic device. In one or more embodiments, the method comprises determining, with a location detector of the electronic device, a location of the electronic device.

In one or more embodiments, the method comprises determining, with one or more processors of the electronic device from the identifying information about the another electronic device, whether the location of the electronic device is proximately located with the another electronic device. In one or more embodiments, where the one or more processors fail to determine that the another electronic device is proximately located with the electronic device, the method comprises presenting, by the one or more processors on a user interface of the electronic device, a prompt comprising a fraud warning.

Advantageously, by obtaining identifying information about another electronic device from an object situated within the environment of the electronic device, the method ensures that the transaction is initiated with the correct ATM, thereby reducing the risk of fraud. This step captures essential details that help verify the authenticity of the transaction.

Determining the location of the electronic device using a location detector allows the system to cross-reference the user's location with the ATM's designated location. This spatial verification is helps to identify potential discrepancies that could indicate fraudulent activity, such as the manipulation of QR codes to redirect transactions to a different ATM.

By using one or more processors to determine whether the location of the electronic device is proximately located with the another electronic device, the method provides a robust mechanism for ensuring that the transaction is being conducted at the intended ATM. This step leverages computational resources to perform real-time validation, enhancing the security of the transaction process.

Moreover, presenting a prompt comprising a fraud warning on the user interface when the processors fail to determine that the another electronic device is proximately located with the electronic device provides an immediate alert to the user. This allows the user to abort the transaction if any discrepancies are detected, thereby preventing potential financial loss. The prompt serves as a critical user interface element that enhances the overall security and user experience by providing real-time feedback and control over the transaction.

Embodiments of the disclosure contemplate that “cardless cash withdrawals” from ATMs have become increasingly popular due to their convenience and the widespread adoption of digital banking services. Users can initiate transactions using their smartphones by scanning a QR code displayed on an ATM. This method eliminates the need for physical cards, thereby streamlining the withdrawal process and enhancing user experience.

However, embodiments of the disclosure also contemplate that this method is ripe for fraud. Indeed, the rise in cardless transactions has also led to an increase in fraudulent activities, posing significant challenges to the security of these transactions.

Existing cardless cash withdrawal systems primarily rely on QR codes to authenticate and process transactions. Users scan a QR code displayed on the ATM, enter the desired withdrawal amount, and authenticate the transaction using their banking credentials. Once authenticated, the ATM dispenses the cash. While this method offers convenience, the method is susceptible to various forms of fraud.

Illustrating by example, fraudsters can manipulate the QR code displayed on the ATM, redirecting the transaction to a different ATM where they can collect the dispensed cash. This manipulation can occur through physical tampering or by overlaying a fake QR code on the ATM's display. As a result, users may unknowingly authorize transactions that dispense cash at a different location, leading to financial losses and complicating the process of rectifying such fraudulent transactions.

The disclosed method advantageously addresses the security vulnerabilities associated with cardless cash withdrawals by incorporating location-based verification. In one or more embodiments, this approach involves capturing the user's location when they scan the QR code on the ATM and cross-referencing the user's location with the ATM's designated location. If there is a discrepancy between the user's location and the ATM's location, the system triggers an alert, allowing the user to abort the transaction. This method effectively mitigates the risk of manipulated QR codes and ensures that the cash withdrawal occurs at the intended ATM, thereby providing an added layer of security that is not present in existing cardless withdrawal systems. Moreover, since ascertaining an ATM's location is as good as ascertaining an ATM's identity, thus determining the ATM's location serves as an additional authentication for user's transaction.

In one or more embodiments, an electronic device comprises a location detector, one or more sensors, one or more processors operable with the location detector and the one or more sensors, and a user interface operable with the one or more processors. In one or more embodiments, the one or more processors present a prompt on the user interface indicating that a financial transaction, initiated with a first remote electronic device situated beyond a predefined threshold from a location determined by the location detector but identified by information the one or more sensors obtained from a second remote electronic device situated within an environment of the electronic device, should be aborted. In one or more embodiments, both the first remote electronic device and the second remote electronic device comprise ATMs.

Advantageously, by incorporating a location detector, one or more sensors, and one or more processors operable with the location detector and the sensors, the electronic device can accurately determine its own location and cross-reference it with the location of the ATM. This arrangement ensures that the transaction is being conducted at the intended ATM, thereby reducing the risk of fraud due to manipulated QR codes.

The user interface operable with the processors allows for real-time alerts to be presented to the user. If the processors determine that the ATM is situated beyond a predefined threshold from the location of the electronic device, a prompt indicating that the financial transaction should be aborted is displayed. This immediate feedback mechanism enhances user security by providing an opportunity to cancel potentially fraudulent transactions before they are completed.

Compared to existing solutions, this method provides an additional layer of security by leveraging location-based verification. The integration of location detection and real-time user alerts ensures that the cash withdrawal occurs at the intended ATM, thereby mitigating the risk of fraud and enhancing the overall security of cardless cash withdrawal systems.

Accordingly, in one or more embodiments a method in an electronic device comprises scanning, with an image capture device, a QR code from an ATM situated within an environment of the electronic device. In one or more embodiments, the method comprises determining, with one or more processors, whether the QR code identifies an ATM location that is proximately located with a location of the electronic device determined by a location detector carried by the electronic device. In one or more embodiments, where the one or more processors fail to determine that the ATM location is proximately located with the location of the electronic device determined by the location detector, the method comprises presenting, by the one or more processors, a prompt on a user interface of the electronic device allowing a financial transaction initiated by the one or more processors with the ATM to be aborted.

Advantageously, by scanning a QR code from an ATM situated within the environment of the electronic device, the method ensures that the transaction is initiated with the correct ATM, thereby reducing the risk of fraud. This step captures essential details that help verify the authenticity of the transaction.

Determining whether the QR code identifies an ATM location that is proximately located with a location of the electronic device determined by a location detector carried by the electronic device allows the system to cross-reference the user's location with the ATM's designated location. This spatial verification helps to identify potential discrepancies that could indicate fraudulent activity, such as the manipulation of QR codes to redirect transactions to a different ATM.

Presenting a prompt on a user interface of the electronic device allowing a financial transaction initiated by the one or more processors with the ATM to be aborted provides an immediate alert to the user. This allows the user to abort the transaction if any discrepancies are detected, thereby preventing potential financial loss. The prompt serves as a critical user interface element that enhances the overall security and user experience by providing real-time feedback and control over the transaction.

Other advantages will be described below. Still others will be obvious to those of ordinary skill in the art having the benefit of this disclosure.

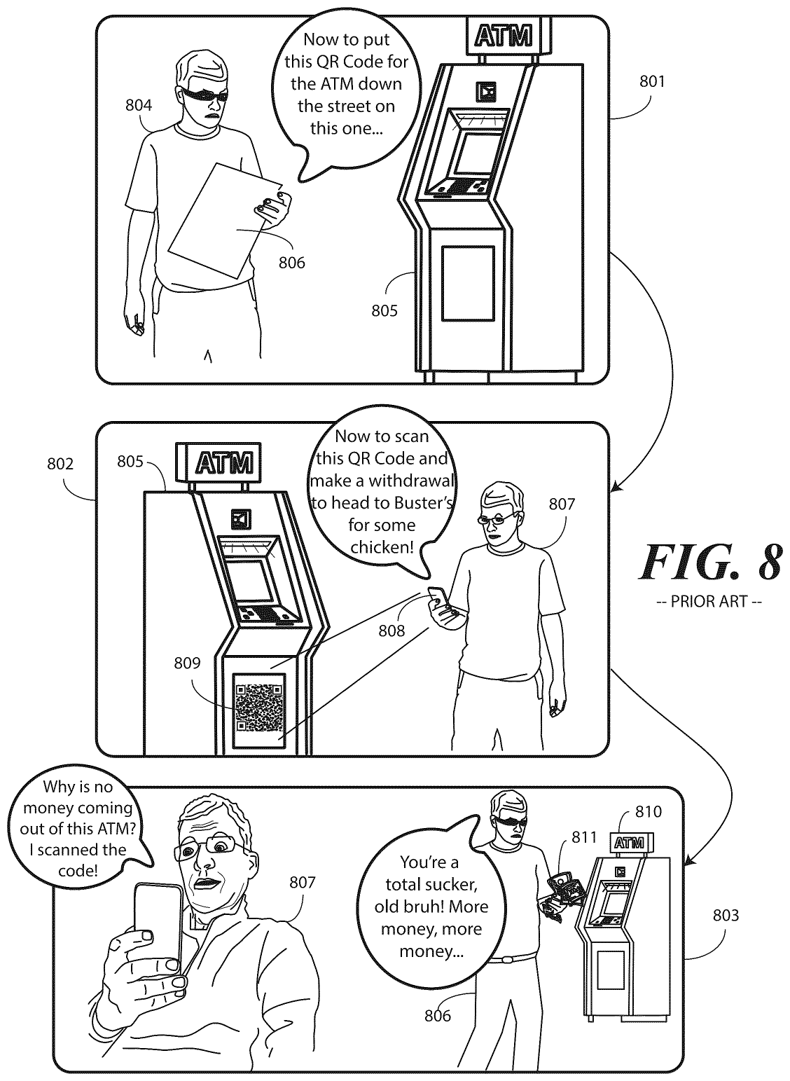

Turning first to FIG. 8, illustrated therein is a prior art method for making a cardless cash withdrawal. As noted above, portable electronic devices such as smartphones are frequently used for banking operations and financial transactions. Illustrating by example, Motorola Mobility has launched a banking application called DIMO.sup.TM in Brazil. Digital banking applications such as DIMO.sup.TM are redefining banking. Indeed, DIMO.sup.TM already has more than one hundred thousand users of the system in Brazil and expects for that number to only continue to grow.

This, as well as other, banking applications are redefining the way that banking occurs. Rather than having to go to a bank to physically talk to a teller during business hours to complete a financial transaction, banking applications offer “24-7” banking with instantaneous transfers of money. Banking can be done exclusively using a smartphone. Even ATM withdrawals can be made using only a smartphone.

The advent of applications such as DIMO.sup.TM have caused people to stop carrying physical credit and debit cards since the credit and debit card account information can simply be loaded into a smartphone, with near field and other communication devices allowing direct transactions of money electronically. Banking applications such as DIMO.sup.TM also allow people to perform banking operations very quickly. The fact that money can be moved instantaneously provides great convenience and saves banking customers large amounts of time.

While this ability to make payments and transfer money is convenient, embodiments of the disclosure contemplate that when cash is involved in a transaction, even sophisticated banking applications with incredible security features can still be hamstrung by the physical interface of a cash disbursement machine, one example of which is an ATM. The ATM must be identified to the banking application so that a cash withdrawal request can occur. This reliance upon older physical interface technology leaves even the most robust electronic banking application subject to the weakness of the physical interface.

To show just how such an interface can be manipulated, at step 801 a nefarious actor a nefarious actor 804 employs a fake QR code sticker 806 to manipulate the transaction process. At step 801, the nefarious actor 804 prepares to attach the fake QR code sticker 806 to an automated teller machine 805. The intention behind this action is to deceive users into scanning the fake QR code 809, which will redirect the withdrawal process to another automated teller machine 810.

At step 802, a user 807 approaches the automated teller machine 805 and scans the fake QR code 809 using a prior art electronic device 808. The user 807 believes that the scanned QR code 809 will initiate a cash withdrawal from the automated teller machine 805 in front of them. Due to the manipulation by the nefarious actor 804, the transaction is redirected to another automated teller machine 810.

At step 803, the user 807 is confused and frustrated as no money is dispensed from the automated teller machine 805, they are using. Meanwhile, the nefarious actor 804 is at the other automated teller machine 810, collecting the cash 811 that was intended for the user 807.

At step 803, the nefarious actor 804 is thrilled that the scam has been successful. Laughing fiendishly, the nefarious actor 804 says, “You're a total sucker, old Bruh!” Paraphrasing the iconic Marc Springer of Snortn' Boar Transport, the fraudster starts saying, “More money, more money, more money!” As shown at step 803, the poor user 807 now understands he has been scammed. Downtrodden and depressed, he laments all the work that must be done to try and get his precious money back, if that is even possible at all.

This fraudulent activity results in financial loss for the user 807 and highlights the vulnerabilities in the existing cardless cash withdrawal systems. Sadly, this happens all too often using prior art systems. Consider the following additional example:

In a scenario where digital payments have become the standard, an individual named Krish encounters a situation requiring physical cash when Krish's cab driver insisted on cash payment, rejecting digital options. Krish therefore decides to withdraw a modest sum of 1000 Rupees from a nearby ATM.

Upon realizing that he left his ATM card behind, Krish opts for the cardless withdrawal option available at the ATM. The process required Krish to scan a QR code displayed on the machine to initiate the transaction. After completing the process on his phone, Krish expects the cash to be dispensed. Sadly, for Krish, no money emerges from the ATM. With no money in hand, he still receives a text confirming that the amount had been deducted from his account.

While failed transactions can be swiftly reversed, sometimes they take longer. As time passes without a reversal, Krish grows concerned and reports the incident to his bank. Subsequent investigations reveal that the amount had indeed been dispensed, but from a different ATM located nearby, not the one Krish had used.

This situation highlights a clear case of fraud, where the QR code on the ATM had been manipulated to redirect the transaction to another ATM. Recovering the money from the bank seems daunting, as Krish took steps to authenticate the transaction himself. Krish decides that pursuing the matter might not be worth the effort, given the relatively small sum involved.

These example experiences underscore the need for new methods, electronic devices, and corresponding systems to verify an ATM's identity when using the cardless mode. The benefit of such an enhancement would be to provide an added layer of security during cardless cash withdrawals.

Advantageously, embodiments of the disclosure do just this. Embodiments of the disclosure employ a location-based verification method to mitigate the risk of manipulated QR codes during cardless ATM withdrawals.

In one or more embodiments the process begins when the user scans the QR code on the ATM to initiate the cash withdrawal. In one or more embodiments, the system captures contextual details about the transaction, including the ATM identifier, transaction details, and the user's location.

In one or more embodiments, the system then validates the ATM location against the user's location through two possible paths: on-device validation or server-side validation. In the on-device validation path, the device requests the ATM details from the server using the ATM identifier or transaction identifier and matches the server-provided ATM location with the user's location. In the server-side validation path, the device sends the user's location along with the transaction identifier to the server, which checks whether the user's location matches the ATM location from where the transaction was requested.

If the user's location does not match the ATM location, in one or more embodiments the system displays an alert on the user's device with an option to abort or proceed with the withdrawal. Optionally, the system can also send the alert via alternate channels such as short message service message, email, or push notifications.

Additionally, the system can show the ATM location on a map for further verification. Depending on the user's decision to proceed or abort the transaction, the system either allows or cancels the withdrawal. Advantageously, embodiments of the disclosure effectively mitigate the risk of manipulated QR codes and ensure that the cash withdrawal occurs at the intended ATM, thereby providing an added layer of security.

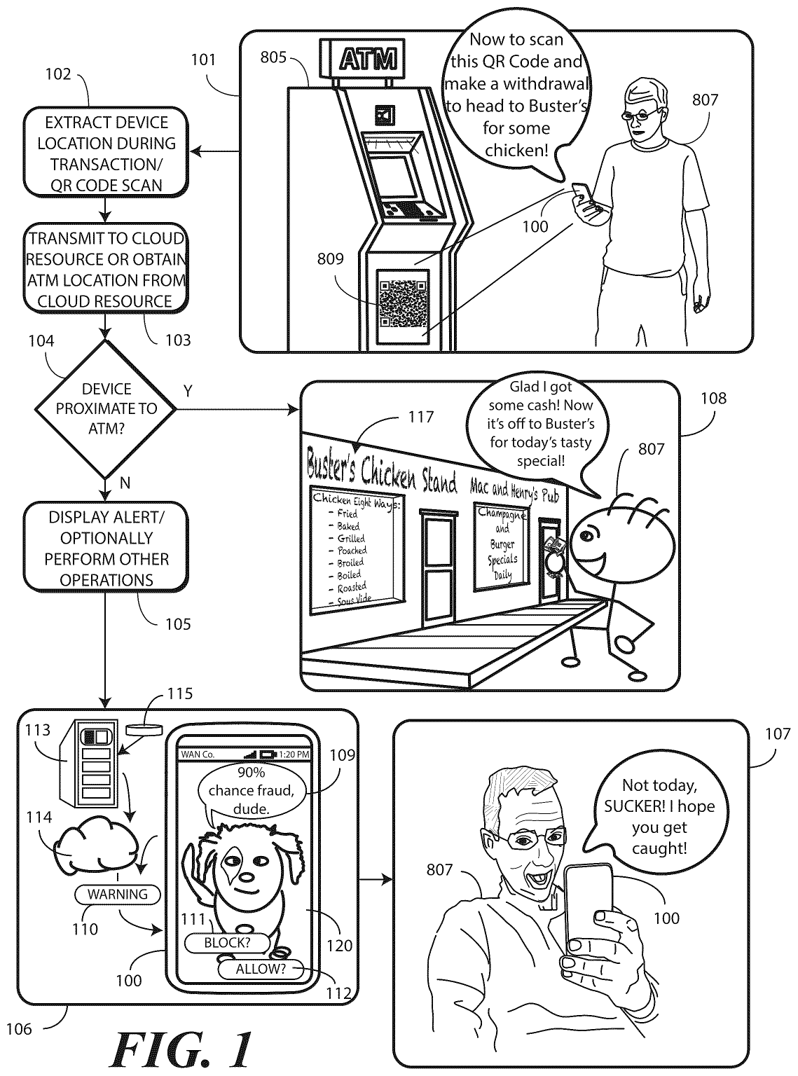

To see how embodiments of the disclosure do this, turn now to FIG. 1. Beginning at step 101, our friendly user 807 is once again attempting to make a cardless cash withdrawal from the ATM 805 bearing the fake QR code 809. However, in FIG. 1, rather than trying to use the prior art electronic device (808) of FIG. 8, the user 807 is armed with an electronic device 100 configured in accordance with one or more embodiments of the disclosure.

At step 101, the electronic device 100 obtains identifying information about another electronic device from an object situated within an environment of the electronic device 100. In one or more embodiments, this occurs using a communication device or one or more sensors of the electronic device 100. In this illustrative example, the other electronic device is the ATM 805, and the object is the fake QR code 809. Said differently, in this illustrative example the object comprises the fake QR code 809 attached the ATM 805 situated within the environment of the electronic device 100.

While the fake QR code 809 is being presented by a sticker attached to the ATM 805, embodiments of the disclosure contemplate that there are other ways the fake QR code 809 could be presented as well. Illustrating by example, a fraudster may place a fake display atop the display of the ATM 805 capable of presenting the fake QR code 809 as well. Other techniques for presenting a fake QR code 809 to commit fraud will be obvious to those of ordinary skill in the art having the benefit of this disclosure.

At step 101 an image capture device of the electronic device 100 captures one or more images of the fake QR code 809 in the form of a QR code scan. Said differently, at step 101 the electronic device 100 obtains the identifying information about the other electronic device by scanning, with the image capture device of the electronic device, the fake QR code 809.

At step 102, a location detector of the electronic device 100 determines the location of the electronic device 100. At decision 104, one or more processors of the electronic device 100 determine whether the location of the electronic device is proximately located with the another electronic device. As noted above, this can be done in one of two ways, namely, locally on the electronic device 100 or with the assistance of a cloud server or other remote electronic device.

In this illustrative example, at step 103 the one or more processors of the electronic device 100 extract identifying information from the fake QR code 809 and transmit it, using a communication device, to a remote electronic device to determine the location of the electronic device identified by the fake QR code 809. Alternatively, the one or more processors of the electronic device 100 could cause the communication device of the electronic device 100 to transmit the location determined at step 102 and the identifying information extracted from the fake QR code 809 to the remote electronic device in another embodiment. In still other embodiments, the determining whether the ATM 805 is proximately located with the electronic device 100 is performed locally on the electronic device by the one or more processors. In one or more embodiments, step 103 further comprises receiving, with the communication device, electronic communication signals identifying whether the another electronic device is proximately located with the electronic device.

In one or more embodiments, the one or more processors can determine, at decision 104, whether the ATM 805 is proximately located with the electronic device 100. In one or more embodiments, decision 104 determines that the ATM 805 is proximately located with the electronic device 100 when the ATM 805 is within a predefined distance threshold from the electronic device 100, one example of which is ten meters. In one or more embodiments, decision 104 is only performed when the identifying information extracted from the QR scan taken at step 101 indicates that the other electronic device identified by the QR scan is an ATM.

Where the one or more processors of the electronic device 100 determine that the ATM 805 is within the predefined distance threshold, this allows the user 807 to run frantically to Buster's Chicken Stand 117, where Buster's world famous chicken is served eight ways. Buster's Chicken Stand 117 is universally renowned for some of its exceptionally good chicken, and just happens to be located next to the equally famous Mac and Henry's Pub, where Champagne and burgers are served daily as a local favorite specialty.

Where the one or more processors fail to determine that the ATM 805 is proximately located with the electronic device 100, in one or more embodiments the one or more processors present, at step 106 on a user interface 120 of the electronic device 100, a prompt 109 comprising a fraud warning 110. Such is the case in this example, since the QR code attached to the ATM 805 is a fake QR code 809. Accordingly, the method moves to step 106.

At step 106, the one or more processors of the electronic device 100 use the user interface 120 of the electronic device 100 to present a prompt 109 comprising a fraud warning 110 indicating that the cardless cash withdrawal from the ATM 805 should be aborted and is likely fraudulent. Here, the prompt 108 includes a warning 110 of fraudulent activity.

In one or more embodiments, step 106 comprises including a user actuation target 111 in the prompt 109 allowing the cardless cash withdrawal to be aborted or to be terminated. In one or more embodiments, when the user 807 actuates the user actuation target 111, the one or more processors of electronic device 100 preclude the performance of any electronic financial transaction requested by the electronic device 100 from the ATM 805.

In this illustrative embodiment, the prompt 109 also includes another user actuation target 112 allowing the user 807 to override the warning 110 set forth in the prompt 109 and complete the cardless cash withdrawal. Some embodiments of the disclosure provide this user actuation target 112 in the off chance that, say, the user 807 is initiating a remote cardless cash withdrawal for a friend at a distant ATM.

Fortunately, here the one or more processors of electronic device 100 cause presentation of the prompt 109 before the cardless cash withdrawal occurs. Accordingly, the user 807 immediately actuates the user actuation target 111 provided by the prompt 109 to block any cash dispensation. In one or more embodiments, actuation of this user actuation target 111 can also preclude the initiation of any electronic financial transaction requested by the electronic device 100 for at least a predefined period of time or until an override code is entered.

As shown at step 107, the user 807 is elated. He exclaims, “Not today, sucker! I hope you get caught.” After successfully thwarting the fraud using embodiments of the disclosure, he decides to treat himself to a delicious pot of dragon well green tea with a few jasmine pearls added for good measure.

It should be noted that the warning 110 can be generated locally by the one or more processors of the electronic device 100 in one or more embodiments. In other embodiments, the electronic device 100 can be in communication with a cloud server 113 across a network 114. In such instances, the cloud server 113 may generate the warning after performing the analysis to determine whether the electronic device 100 and ATM 805 are proximately located. The use of a cloud server 113 is advantageous, for example, when the determination of one or both of location of the electronic device 100 or the location of the ATM 805 utilizes a generative artificial intelligence engine 115.

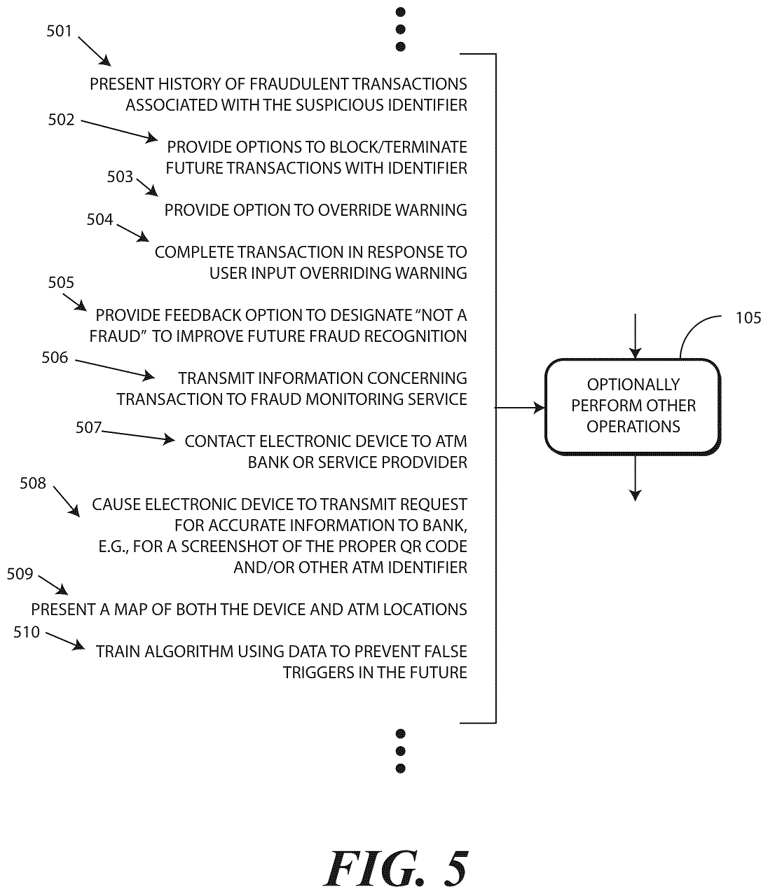

Other steps can optionally be performed in addition to the presentation of the prompt 109. Illustrating by example, optional step 106 can provide additional details about the location of the ATM to which the cash would be dispensed. Step 106 can comprise presenting a map with the location of the electronic device 100 and the dispensing ATM, for example. Other steps that can be taken will be described below with reference to FIG. 5. Still others will be obvious to those of ordinary skill in the art having the benefit of this disclosure.

Advantageously, the disclosed method for preventing fraud during cardless cash withdrawals involves a system that cross-references the user's location with the ATM's designated location to detect potential discrepancies. This system aims to mitigate the risk of manipulated QR codes in ATM withdrawals by validating the ATM location against the user's location and alerting the user if there is a mismatch.

In one or more embodiments, the method involves capturing the user's location and the ATM's details, validating the ATM location against the user's location, and alerting the user if there is a discrepancy. As noted above, the problem of QR code manipulation in cardless ATM withdrawals is well-documented, but the proposed solution of using location-based verification to detect and prevent such fraud new and novel. Indeed, the method of FIG. 1 involves a specific sequence of steps and the use of both device-side and server-side validation, which adds a layer of complexity and security that is not evident in existing technologies.

Moreover, the method is useful as the method addresses a significant problem in the field of digital banking and cardless ATM withdrawals. By providing steps to verify the ATM's identity and alert the user to potential discrepancies, the method enhances the security of cardless cash withdrawals and helps prevent fraud.

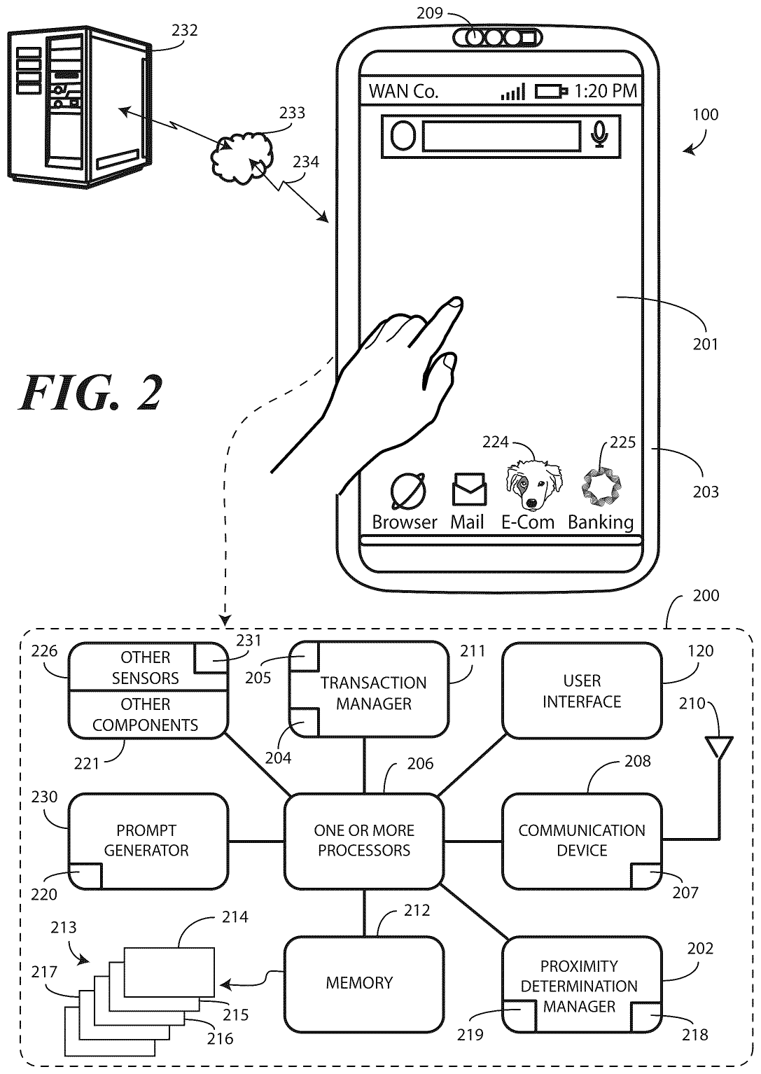

Turning now to FIG. 2 illustrated therein is one electronic device 100 configured in accordance with one or more embodiments of the disclosure. The electronic device 100 of this illustrative embodiment includes a user interface 120. In one or more embodiments, the user interface 120 comprises a display 201, which may optionally be touch-sensitive. The display 201 can serve as a primary user interface 120 of the electronic device 100.

Where the display 201 is touch sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 100 of FIG. 2 includes a housing 203. Features can be incorporated into the housing 203. Examples of features that can be included along the housing 203 include an imager or other image capture device 209, shown as a camera in FIG. 2, or an optional speaker port. A user interface component, which may be a button or touch sensitive surface, can also be disposed along the housing 203.

A block diagram schematic 200 of the electronic device 100 is also shown in FIG. 2. In one embodiment, the electronic device 100 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device.

The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 212, can optionally store the executable software code used by the one or more processors 206 during operation.

In this illustrative embodiment, the electronic device 100 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas 210.

The electronic device 100 can optionally include a near field communication circuit 207 used to exchange data, power, and electrical signals between the electronic device 100 and another electronic device. In one embodiment, the near field communication circuit 207 is operable with a wireless near field communication transceiver, which is a form of radio-frequency device configured to send and receive radio-frequency data to and from the companion electronic device or other near field communication objects.

Where included, the near field communication circuit 207 can have its own near field communication circuit controller in one or more embodiments to wirelessly communicate with companion electronic devices using various near field communication technologies and protocols. The near field communication circuit 207 can include—as an antenna—a communication coil that is configured for near-field communication at a particular communication frequency.

The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 100. For example, in one embodiment the one or more processors 206 comprise one or more circuits operable to present presentation information, such as images, text, and video, on the display 201. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 100.

The application service layer 215 can be responsible for executing application service modules. The application service modules may support one or more applications 217 or “apps.” Examples of such applications include a cellular telephone application for making voice telephone calls, a web browsing application configured to allow the user to view webpages on the display 201 of the electronic device 100, an electronic mail application configured to send and receive electronic mail, a photo application configured to organize, manage, and present photographs on the display 201 of the electronic device 100, and a camera application for capturing images with the image capture device 209. Collectively, these applications constitute an “application suite.” In one or more embodiments, these applications comprise one or more e-commerce applications 224 and/or banking applications 225 that allow electronic commerce orders to be placed and financial transactions, one example of which is cardless cash withdrawals, to be made using the electronic device 100.

Illustrating by example, in one or more embodiments a user can deliver user input to a banking application 225 to cause the image capture device 209 to capture a QR code scan 204 of an ATM to initiate a cardless cash withdrawal. In one or more embodiments, when this happens, a transaction manager 211 can determine a location 205 of the electronic device 100 using one or more sensors 226, which can include a location detector 231.

Thereafter, the transaction manager 211 can extract identifying information form the QR code scan 204 and cause the communication device 208 to transmit the identifying information to a remote electronic device 232, one example of which is a cloud server, across a network 233. In one or more embodiments, the remote electronic device 232 then sends a location 219 of the device to which the QR code from which the QR code scan 204 was taken so that a proximity determination manager 202 can determine whether the location 205 of the electronic device 100 and the location received via electronic communication signals 234 are proximately located. In one or more embodiments, the proximity determination manager 202 does this by determining whether the device to which the QR code from which the QR code scan 204 was taken and the electronic device 100 are situated within a predefined distance threshold 218 relative to each other. This constitutes determining whether another electronic device is proximately located with the electronic device 100, with that determination being performed locally on the electronic device 100 using the one or more processors 206, which operate the transaction manager 211 and/or the proximity determination manager 202 in one or more embodiments.

In other embodiments, the transaction manager 211 may cause the communication device 208 to transmit both the location 205 of the electronic device 100 and the identifying information extracted from the QR code scan 204 to the remote electronic device 232. Thereafter, the determination of whether the electronic device from which the QR code scan 204 was taken is proximately located with the electronic device 100 comprises receiving, by the proximity determination manager 202 with the communication device 208, electronic communication signals 234 identifying whether the electronic device from which the QR code scan 204 was taken and the electronic device 100 are proximately located. This constitutes the remote electronic device 100 determining whether another electronic device is proximately located with the electronic device 100 with that determination being delivered to the proximity determination manager 202.

In one or more embodiments, where the one or more processors 206 fail to determine that another electronic device from which the QR code scan 204 is taken, such as an ATM, is proximately located with the electronic device 100, a prompt generator 230 presents a prompt 220 comprising a fraud warning. In a situation where a fraudster places a fake QR code on one ATM intending money to be dispensed from another ATM, this type of fraud would advantageously be prevented. This is true because in one or more embodiments, the prompt generator 230 is configured to present a prompt 220 on the user interface 120 indicating that a financial transaction, such as a cardless cash withdrawal, initiated with a first remote electronic device, such as a first ATM, situated beyond a predefined threshold from a location 205 determined by the location detector 231, but identified by information, such as the QR code scan 204, the one or more sensors obtained from a second remote electronic device, such as a second ATM situated within an environment of the electronic device 100, should be aborted.

In one or more embodiments, the one or more processors 206 are responsible for managing the applications and all personal information received from the user interface 120 that is to be used by the e-commerce application 224 and/or banking application 225 after the electronic device 100 is authenticated as a secure electronic device. The one or more processors 206 can also be responsible for launching, monitoring, and killing the various applications and the various application service modules. In one or more embodiments, the one or more processors 206 are operable to not only kill the applications, but also to expunge any and all personal data, data, files, settings, or other configuration tools when the electronic device 100 is reported stolen or when the e-commerce application 224 and/or banking application 225 are used with fraudulent activity to wipe the memory 212 clean of any personal data, preferences, or settings of the person previously using the electronic device 100.

The one or more processors 206 can also be operable with other components 221. The other components 221, in one embodiment, include input components, which can include acoustic detectors as one or more microphones. The one or more processors 206 may process information from the other components 221 alone or in combination with other data, such as the information stored in the memory 212 or information received from the user interface.

The other components 221 can include a video input component such as an optical sensor, another audio input component such as a second microphone, and a mechanical input component such as button. The other components 221 can include one or more sensors 226, which may include key selection sensors, touch pad sensors, capacitive sensors, motion sensors, and switches. Similarly, the other components 221 can include video, audio, and/or mechanical outputs.

The one or more sensors 226 may include, but are not limited to, accelerometers, touch sensors, surface/housing capacitive sensors, audio sensors, and video sensors. Touch sensors may be used to indicate whether the electronic device 100 is being touched at side edges. The other components 221 of the electronic device can also include a device interface to provide a direct connection to auxiliary components or accessories for additional or enhanced functionality and a power source, such as a portable battery, for providing power to the other internal components and allow portability of the electronic device 100.

As noted above, in one or more embodiments the electronic device 100 comprises a prompt generator 230. In one or more embodiments, the prompt generator 230 generates a prompt 220 on the user interface 120 of the electronic device 100 allowing a financial transaction initiated by the one or more processors 206 with an ATM to be aborted. In one or more embodiments, this prompt 220 is presented where the one or more processors 206 and/or the proximity determination manager 202 fail to determine that the ATM location 219 is proximately located with the location 205 of the electronic device 100 determined by the location detector 231.

Thus, in one or more embodiments the image capture device 209 scans a QR code from an ATM situated within an environment of the electronic device 100, while the one or more processors 206 and/or the proximity determination manager 202 determine whether the QR code identifies an ATM location 219 that is proximately located with a location 205 of the electronic device 100 as determined by the location detector 231. In one or more embodiments, where the one or more processors 206 and/or the proximity determination manager 202 fail to determine that the ATM location 219 is proximately located with the location 205 of the electronic device 100 determined by the location detector 231, the prompt generator 230 presents a prompt 220 on the user interface 120 of the electronic device 100 allowing a financial transaction initiated by the one or more processors 206 with the ATM to be aborted.

In one or more embodiments, the transaction manager 211 and the prompt generator 230 can be operable with one or more processors 206, configured as a component of the one or more processors 206, or configured as one or more executable code modules operating on the one or more processors 206. In other embodiments, the transaction manager 211 and the prompt generator 230 can be standalone hardware components operating executable code or firmware to perform their functions. Other configurations for the transaction manager 211 and the prompt generator 230 will be obvious to those of ordinary skill in the art having the benefit of this disclosure.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

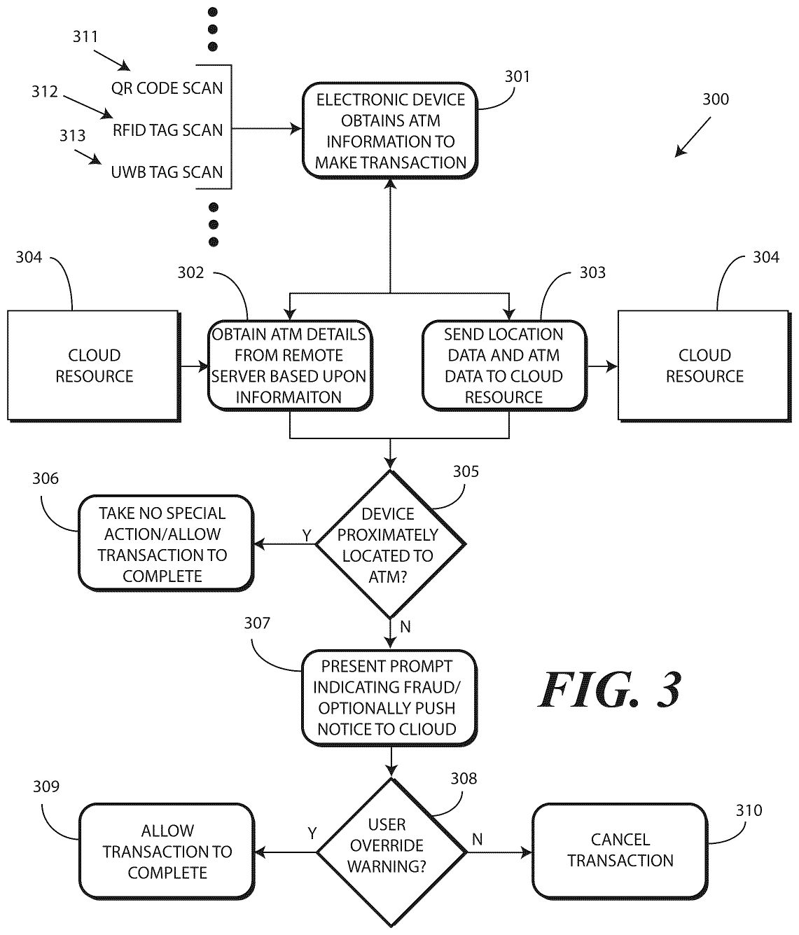

Turning now to FIG. 3, illustrated therein is one explanatory method 300 in accordance with one or more embodiments of the disclosure. Beginning at step 301, the method 300 obtains, with a communication device or one or more sensors of an electronic device, identifying information about another electronic device from an object situated within an environment of the electronic device. In one or more embodiments, the object comprises a QR code attached to, or presented by, an ATM situated within an environment of the electronic device. This results in step 301 comprising obtaining the identifying information by scanning, with an image capture device of the electronic device, the QR code to obtain a QR code scan 311.

Thus, in a primary embodiment step 301 of FIG. 3 comprises scanning a QR code with an image capture device to obtain a QR code scan 311. This method leverages the widespread availability and familiarity of QR codes, making a practical and user-friendly approach for initiating cardless cash withdrawals. The image capture device, typically a camera integrated into the electronic device, captures the QR code, which contains the necessary transaction information. This method ensures a straightforward and efficient process for users, as QR codes are easily scannable and can be quickly processed by the electronic device. However, step 301 can be performed in other ways as well.

Alternatively, step 301 could be performed using a near-field communication (NFC) circuit to read an RFID tag, thereby obtaining an RFID tag scan 312. This method offers the advantage of contactless interaction, enhancing the security and convenience of the transaction. The NFC circuit, embedded within the electronic device, communicates with the RFID tag by emitting a radio frequency signal. This signal powers the RFID tag, allowing the RFID tag to transmit the stored transaction information back to the electronic device. The use of NFC technology reduces the risk of physical tampering and provides a seamless user experience, as users only need to bring their device close to the RFID tag to initiate the transaction.

Another alternative for step 301 involves using an ultra-wideband (UWB) component of the electronic device to read an ultra-wideband tag, resulting in an ultra-wideband tag scan 313. UWB technology offers high precision in determining the location and distance between the electronic device and the tag. This method enhances the accuracy of the transaction initiation process, ensuring that the electronic device is in close proximity to the intended ATM. The UWB component emits short pulses of radio waves, which are received by the ultra-wideband tag. The tag then responds with a signal, allowing the electronic device to accurately determine the location and obtain the necessary transaction information. This method provides a robust and secure alternative to QR code scanning, particularly in environments where precise location verification is required.

Other alternatives for step 301 may include using Bluetooth Low Energy (BLE) beacons, infrared communication, or even acoustic signals to obtain the necessary transaction information. Each of these methods offers advantages in terms of security, convenience, and accuracy, allowing for a flexible and adaptable approach to initiating cardless cash withdrawals. By incorporating various technologies, the system can cater to different user preferences and environmental conditions, ensuring a secure and efficient transaction process. Still other techniques for performing step 301 will be obvious to those of ordinary skill in the art having the benefit of this disclosure.

In one or more embodiments, step 301 also comprises determining, with a location detector of the electronic device, a location of the electronic device. In one or more embodiments, the determining the location of the electronic device occurs concurrently with the obtaining the identifying information at step 301. In one or more embodiments, this occurs when step 301 detects, by one or more processors of the electronic device, an initiation of a financial transaction using an ATM.

From step 301, the method 300 then determines, with one or more processors of the electronic device from the identifying information about the other electronic device at decision 305, whether the location of the electronic device is proximately located with the another electronic device. In one or more embodiments, this comprises determining whether the other electronic device is within a predefined distance threshold from the electronic device.

As noted above, this determination can occur in two ways. Illustrating by example, at step 302 the determining whether the other electronic device is proximately located with the electronic device is performed locally on the electronic device by the one or more processors. By contrast, at step 303 the determining whether the other electronic device is proximately located with the electronic device is performed with the help of a remote electronic device 304, one example of which is a cloud resource or cloud server. In one or more embodiments, this determination that the another electronic device is proximately located with the electronic device occurs only when the another electronic device is an ATM.

In one or more embodiments, step 302 comprises obtaining, by a communication device from a remote electronic device 304 across a network using the identifying information, a location of the another electronic device. Illustrating by example, step 302 can comprise transmitting, with a communication device, information extracted from the QR code to a remote electronic device 304 across a network and receiving, with the communication device, location information from the remote electronic device. Decision 305 then comprises comparing, with the one or more processors, the location information received from the remote electronic device to the location of the electronic device determined by the location detector. Said differently, the determination of whether the other electronic device is proximately located with the electronic device at decision 305 is then performed locally on the electronic device by its one or more processors by comparing the location of the electronic device to the location of the other electronic device received from the remote electronic device 304.

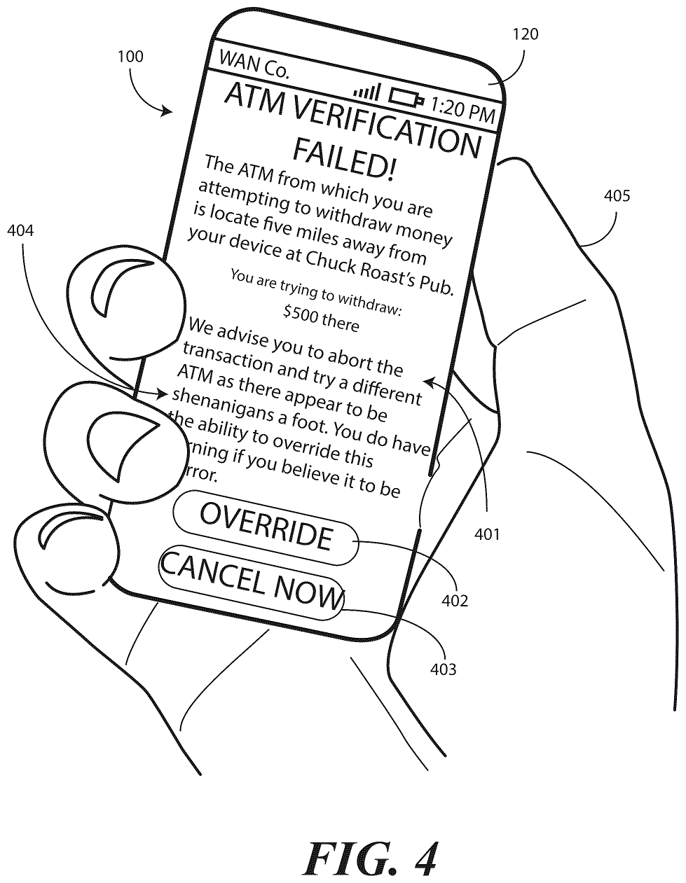

In other embodiments, step 303 comprises transmitting, with the communication device, the location of the electronic device and the identifying information to a remote electronic device 304 across a network. Said differently, in one or more embodiments step 303 comprises transmitting, with a communication device, the location of the electronic device determined by the location detector and information extracted from the QR code to a remote electronic device 304 across a network and receiving, with the communication device, a determination whether the ATM location is proximately located with the location of the electronic device determined by the location detector. Decision 305, in such an embodiment comprises determining whether the other electronic device is proximately located with the electronic device by receiving, with the communication device, electronic communication signals identifying whether the another electronic device is proximately located with the electronic device.

Where the other electronic device and the electronic device are proximately located, step 306 takes no action. By contrast, where decision 305 fails to determine that the other electronic device is proximately located with the electronic device, the method 300 moves to step 307. In one or more embodiments, step 307 comprises presenting, by the one or more processors on a user interface of the electronic device, a prompt comprising a fraud warning. In one or more embodiments, the prompt comprises a user actuation target allowing the financial transaction to be aborted. In one or more embodiments, the prompt comprises a user actuation target allowing an authorized user of the electronic device to override the prompt as well. Turning briefly to FIG. 4, illustrated therein is one example of such a prompt 401.

As shown in FIG. 4, a prompt 401 is being presented on a user interface 120 of an electronic device 100. In this illustrative embodiment, the prompt 401 comprises a fraud warning 404. Additionally, the prompt 401 comprises a user actuation target 403 allowing the financial transaction to be aborted. In this illustrative embodiment, the prompt 401 comprises a user actuation target 402 allowing an authorized user 405 of the electronic device 100 to override the prompt 401 as well.

Thus, as shown, FIG. 4 shows an embodiment of a prompt 401 displayed on an electronic device 100 held by a user 807. The prompt 401 indicates a failed ATM verification due to a lack of sufficient proximity between the electronic device 100 and an ATM and provides options for the user 807 to respond to the situation. The prompt 401 is part of a system designed to prevent fraud during cardless cash withdrawals by verifying the proximity of the ATM to the user's location.

In this illustrative embodiment, the prompt 401 displays a message informing the user 807 that the ATM from which they are attempting to withdraw money is located five miles away from their current location. The message advises the user 807 to abort the transaction and try a different ATM due to potential for fraudulent activity. In this illustrative embodiment, the prompt 401 also provides the user 807 with the ability to override the warning if the user 807 believes the warning to be an error.

The user actuation target (UAT) 402 is included in the prompt 401, allowing the user 807 to override the warning and proceed with the transaction. The user actuation target 402 is prominently displayed to ensure that the user 807 can easily access this option if they choose to continue with the transaction despite the warning.

The user 807 interacts with the prompt 401 on the electronic device 100, which is designed to enhance the security of cardless cash withdrawals by providing real-time alerts and options for the user 807 to respond to potential fraud. The system aims to mitigate the risk of manipulated QR codes and ensure that the cash withdrawal occurs at the intended ATM.

Turning now back to FIG. 3, decision 308 then determines whether additional user input is received that overrides the fraud warning. Where it does, step 309 allows the financial transaction to complete. By contrast, when user actuation target allowing the financial transaction to be overridden is not actuated, or alternatively when another user actuation target allowing the financial transaction to be aborted is actuated, step 310 aborts the financial transaction.

As noted above with reference to step (105) of FIG. 1, and as is also applicable to the method 300 of FIG. 3, in one or more embodiments other operations can be performed. Turning now to FIG. 5, illustrated therein are some other operations that can be performed at step 105, which can be included in the method (300) of FIG. 3 as well.

FIG. 5 shows additional operations that can be performed at step 105 of either the method depicted above with reference to FIG. 1 or the method 300 of FIG. 3. These additional operations are labeled as operations 501-510 in FIG. 5.

At operation 501, step 105 presents the history of fraudulent transactions associated with the suspicious identifier. If, for example, several people have been scammed by a fake QR code at a particular machine, operation 501 may share the details of how the scam occurred, and so forth, with the user receiving the prompt. This operation 501 allows the user to review past fraudulent activities linked to the identifier, providing context for the current warning.

At operation 502, step 105 provides options to block or terminate future transactions with the identifier. In one or more embodiments, the memory of the electronic device can store the QR code scan in a database. Thus, if the image capture device scans the same QR code in the future, the one or more processors of the electronic device can preclude any financial transaction from occurring since the QR code scan is recognized. This operation enables the user to prevent further transactions from being processed with the suspicious identifier, enhancing security.

At operation 503, step 105 provides an option to override the warning. As noted above, a user actuation target can be included with the prompt that, when actuated, overrides the fraud warning. This step allows the user to proceed with the transaction despite the warning, offering flexibility in case of false positives. At operation 504, step 105 completes the transaction in response to user input overriding the warning. This step ensures that the transaction is processed if the user decides to proceed after reviewing the warning.

At operation 505, step 105 provides a feedback option to designate the transaction as “not a fraud” to improve future fraud recognition. This step helps refine the system's fraud detection algorithms by incorporating user feedback.

At operation 506, step 105 transmits information concerning the transaction to a fraud monitoring service. This step ensures that relevant details are shared with monitoring services for further analysis and action.

At operation 507, step 105 contacts the electronic device to the ATM bank or service provider. This step establishes communication with the bank or service provider to address the potential fraud.

At operation 508, step 105 causes the electronic device to transmit a request for accurate information to the bank, such as a screenshot of the proper QR code and/or another ATM identifier. In one or more embodiments, this operation 508 allows the user to complete a cardless cash withdrawal using the ATM at his location, despite the fact that a fraudster has tampered with the QR code being presented, or affixed to, that ATM.

At operation 509, step 105 presents a map of both the device and ATM locations. In one or more embodiments, this operation 508 comprises presenting a map identifying both the location of the electronic device and another location of the first remote electronic device identified by the QR code scan. When a fraudster has created a QR code to dispense cash from a distant ATM, this step helps the user to locate where that distant machine is so that the user can tip off the authorities.

At operation 510, step 105 trains the algorithm using data to prevent false triggers in the future. This step enhances the system's accuracy by incorporating data from past transactions to refine the fraud detection process. Of course, these operations could be performed at step 105 alone or in combination. Additionally, other operations that could be performed at step 105 will be obvious to those of ordinary skill in the art having the benefit of this disclosure.

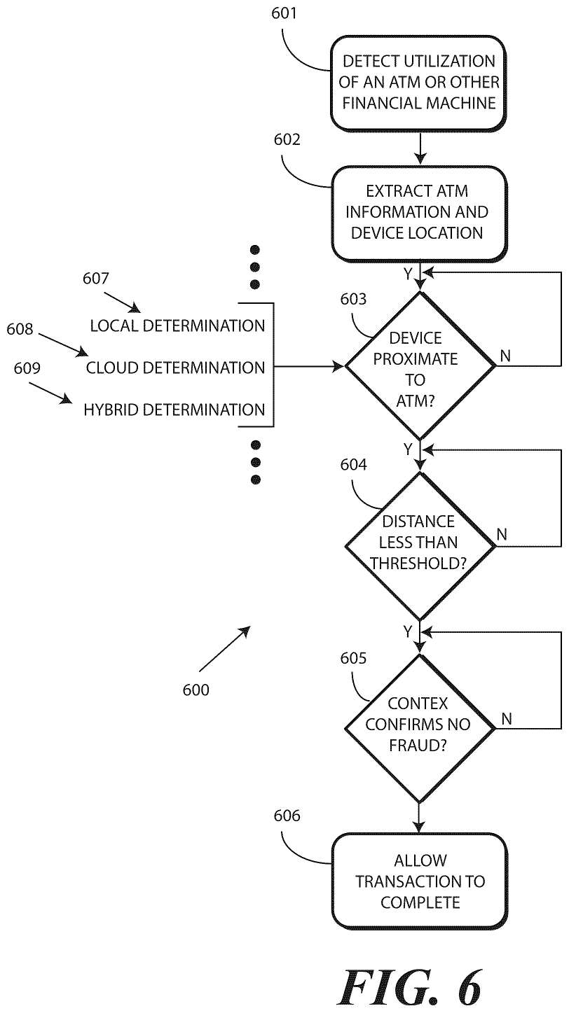

Turning now to FIG. 6, illustrated therein is another method 600 in accordance with one or more embodiments of the disclosure. To with, FIG. 6 shows a method 600 for preventing fraud during cardless cash withdrawals by employing location-based verification.

The method 600 begins at step 601, where the system detects the utilization of an ATM or other financial machine. This detection initiates the process of verifying the transaction's authenticity.

At step 602, the system extracts ATM information and the device location. In one or more embodiments, this step 602 comprises performing a can of a QR code presented by, or affixed to, an ATM. Step 602 can optionally comprise extracting identifying information from the QR scan as well. As noted above with reference to FIG. 3, bar code scans, NFC tag scans, ultra-wideband tag scans, or other visual or electronic signal scans can be substituted for the scan of the QR code. Regardless of which technique is used, in one or more embodiments this step captures details about the machine, including the ATM identifier. In one or more embodiments, step 602 also involves using a location detector to detect the user's location. This information can then be used for subsequent verification steps.

Decision 603 determines whether the device is near the ATM. As noted above, this decision 603 can be performed locally 607 on one or more processors of the electronic device, performed remotely using a cloud server 608 or other remote electronic device, or performed using a hybrid determination technique 609 where some of the determination steps are performed locally and others are performed by a cloud server 608 or another remote electronic device. Regardless of how the decision 603 is made, in one or more embodiments the decision 603 involves checking if the user's device is near the ATM from which the transaction is being initiated. If the device is not near the ATM, the process may trigger an alert or abort the transaction to prevent potential fraud as previously described.

Decision 604 checks if the context of the situation suggests fraud. In one or more embodiments, this decision 604 determines distance between the device and the ATM is less than a predefined threshold. This decision 604 ensures that the transaction is being conducted within an acceptable range, further verifying the legitimacy of the transaction. If the distance exceeds the threshold, the system may flag the transaction as suspicious.

Decision 605 involves considering context confirmation to ensure no fraud is detected. This step uses additional contextual information to verify the transaction's authenticity.

Illustrating by example, the additional contextual information considered by decision 605 may include various data points and parameters that provide a comprehensive view of the transaction environment. This information can encompass the time of the transaction, the frequency of transactions from the same ATM, the user's transaction history, and the typical behavior patterns of the user. For instance, if the transaction occurs at an unusual time, such as late at night, or if there have been multiple transactions from the same ATM within a short period, these factors may suggest potentially fraudulent activity.

Moreover, decision 605 may consider the geographical location of the user relative to their usual transaction locations. If the user's device is detected in a location far from their typical transaction areas, this could indicate that the transaction is being initiated by someone not the authorized user. Additionally, the system may analyze the type of transaction being performed. For example, if the transaction involves a large withdrawal amount that deviates significantly from the user's usual withdrawal patterns, this could raise a red flag for potential fraud.

Other contextual information may include the device's security status, such as whether the device has been recently compromised or if there are any signs of malware. The system may also check for any recent changes in the user's account settings or contact information, which could indicate unauthorized access. By considering these additional contextual factors, decision 605 can more accurately determine the likelihood of fraudulent activity and take appropriate actions to protect the user's financial assets. If any discrepancies or signs of fraud are detected, the system may alert the user or abort the transaction.

Step 606 allows the transaction to complete if all previous checks are satisfied. This step ensures that the transaction proceeds only when the system confirms the user's location and the ATM's location are consistent and no fraud is detected.

The method 600 includes three possible paths for determining the proximity of the device to the ATM: local determination 607, cloud determination 608, and hybrid determination 609. Local determination 607 performs the verification on the user's device, cloud determination 608 involves a remote server to verify the proximity, and hybrid determination 609 combines both local and cloud resources for verification. These paths provide flexibility in how the system verifies the transaction, enhancing the overall security and reliability of the process.

In sum, embodiments of the disclosure offer several advantages that enhance the security and reliability of cardless cash withdrawals. By transmitting the location of the electronic device determined by the location detector and information extracted from the QR code to a remote electronic device across a network, the embodiments of the disclosure ensure that the transaction is initiated with the correct ATM. Embodiments of the disclosure capture details that help verify the authenticity of the transaction, thereby reducing the risk of fraud. The electronic device, or alternatively a remote electronic device or combination of the electronic device and the remote electronic device, then performs a determination whether the ATM location is proximately located with the location of the electronic device determined by the location detector. This verification adds an additional layer of security by leveraging external resources to validate the transaction, ensuring that the cash withdrawal occurs at the intended ATM.

Furthermore, embodiments of the disclosure can include receiving, with a communication device, a determination whether the ATM location is proximately located with the location of the electronic device determined by the location detector. This provides real-time feedback to the user, allowing for immediate action if any discrepancies are detected. By comparing the location information received from the remote electronic device to the location of the electronic device determined by the location detector, embodiments of the disclosure provide a robust mechanism for spatial verification. This spatial verification helps to identify potential discrepancies that could indicate fraudulent activity, such as the manipulation of QR codes to redirect transactions to a different ATM. The prompt presented on the user interface of the electronic device allows the user to abort the transaction if any discrepancies are detected, thereby preventing potential financial loss.

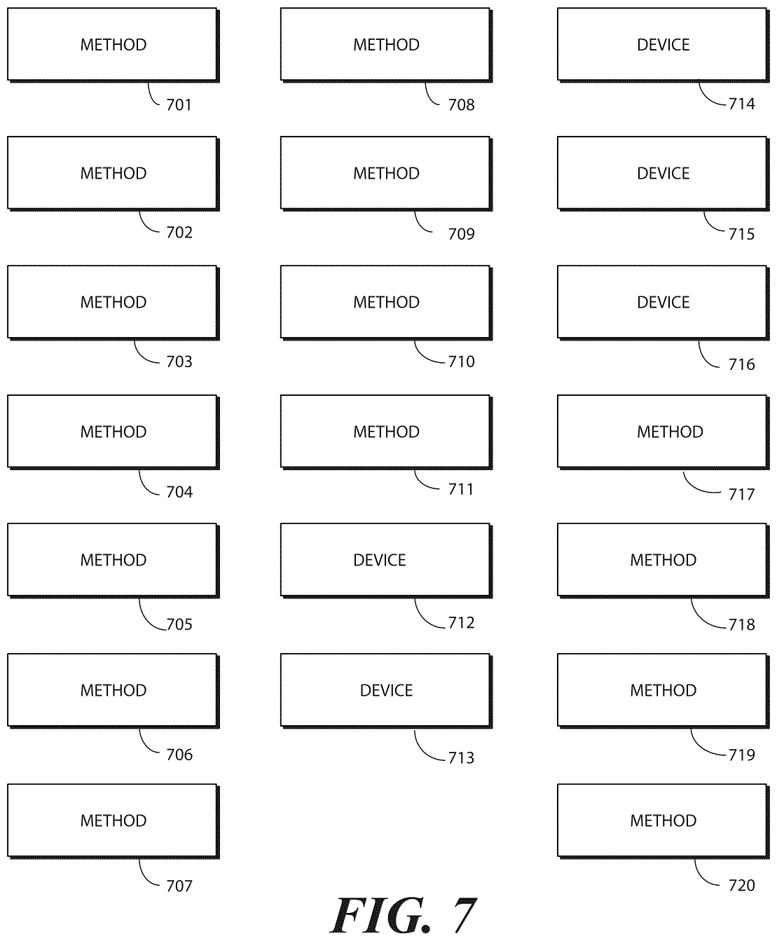

Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

At 701, a method in an electronic device comprises obtaining, with a communication device or one or more sensors of the electronic device, identifying information about another electronic device from an object situated within an environment of the electronic device. At 701, the method comprises determining, with a location detector of the electronic device, a location of the electronic device;

At 701, the method comprises determining, with one or more processors of the electronic device from the identifying information about the another electronic device, whether the location of the electronic device is proximately located with the another electronic device. At 701, where the one or more processors fail to determine that the another electronic device is proximately located with the electronic device, the method comprises presenting, by the one or more processors on a user interface of the electronic device, a prompt comprising a fraud warning.

At 702, the objection of 701 comprises a QR code attached to or presented by an ATM situated within the environment of the electronic device. At 702, the obtaining the identifying information comprises scanning, with an image capture device of the electronic device, the QR code.

At 703, the one or more processors of 702 determine that the another electronic device is proximately located with the electronic device when the another electronic device is the ATM. At 704, the determining of 702 whether the another electronic device is proximately located with the electronic device comprises determining whether the another electronic device is within a predefined distance threshold from the electronic device.

At 705, the method of 704 further comprises obtaining, by the communication device from a remote electronic device across a network using the identifying information, a location of the another electronic device. At 706, the determining of 705 whether the another electronic device is proximately located with the electronic device is performed locally on the electronic device by the one or more processors.

At 707, the method of 704 further comprises transmitting, with the communication device, the location of the electronic device and the identifying information to a remote electronic device across a network. At 708, the determining of 707 whether the another electronic device is proximately located with the electronic device comprises receiving, with the communication device, electronic communication signals identifying whether the another electronic device is proximately located with the electronic device.

At 709, the prompt of 702 comprises a user actuation target allowing an authorized user of the electronic device to override the prompt. At 710, the determining of 702 the location of the electronic device occurs concurrently with the obtaining the identifying information. At 711, the method of 710 further comprises detecting, by the one or more processors, an initiation of a financial transaction using the ATM. At 711, the prompt comprises a user actuation target allowing the financial transaction to be aborted.

At 712, an electronic device comprises a location detector, one or more sensors, one or more processors operable with the location detector and the one or more sensors, and a user interface operable with the one or more processors. At 712, the one or more processors present a prompt on the user interface indicating that a financial transaction, initiated with a first remote electronic device situated beyond a predefined threshold from a location determined by the location detector but identified by information the one or more sensors obtained from a second remote electronic device situated within an environment of the electronic device, should be aborted.

At 713, the first remote electronic device of 712 and the second remote electronic device both comprise ATMs. At 714, the information of 713 is presented in a QR code scanned by the one or more sensors from a surface or a display of the second remote electronic device.

At 715, the prompt of 714 comprises a user actuation target allowing an authorized user of the electronic device to override the prompt. At 716, the one or more processors of 715 further cause the user interface to present a map identifying both the location of the electronic device and another location of the first remote electronic device.

At 717, a method in an electronic device comprises scanning, with an image capture device, a quick reference (QR) code from an automated teller machine (ATM) situated within an environment of the electronic device. At 717, the method comprises determining, with one or more processors, whether the QR code identifies an ATM location that is proximately located with a location of the electronic device determined by a location detector carried by the electronic device. At 717, where the one or more processors fail to determine that the ATM location is proximately located with the location of the electronic device determined by the location detector, the method comprises presenting, by the one or more processors, a prompt on a user interface of the electronic device allowing a financial transaction initiated by the one or more processors with the ATM to be aborted.

At 718, the determining of 717 whether the ATM location is proximately located with the location of the electronic device determined by the location detector comprises transmitting, with a communication device, the location of the electronic device determined by the location detector and information extracted from the QR code to a remote electronic device across a network and receiving, with the communication device, a determination whether the ATM location is proximately located with the location of the electronic device determined by the location detector.

At 719, the determining of 717 whether the ATM location is proximately located with the location of the electronic device determined by the location detector comprises transmitting, with a communication device, information extracted from the QR code to a remote electronic device across a network and receiving, with the communication device, location information from the remote electronic device; and comparing, with the one or more processors, the location information received from the remote electronic device to the location of the electronic device determined by the location detector.

At 720, the ATM location of 717 is proximately located with the location of the electronic device determined by the location detector when a distance between the ATM location and the location of the electronic device determined by the location detector is less than a predefined distance threshold.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in one or more embodiments the electronic device comprises a location detector, one or more sensors, one or more processors operable with the location detector and the one or more sensors, and a user interface operable with the one or more processors. The location detector can be a GPS module or other geolocation technology capable of determining the precise location of the electronic device. The sensors may include an image capture device, such as a camera, for scanning QR codes, as well as other sensors like accelerometers, gyroscopes, or proximity sensors to gather contextual data. The processors are configured to execute software that can analyze the data from the sensors and location detector to determine if the electronic device is near the ATM from which a transaction is being initiated. The user interface, which could be a touchscreen display, presents prompts and alerts to the user, including fraud warnings if the device's location does not match the ATM's location.

In another embodiment, the electronic device may also include a communication device, such as a cellular or Wi-Fi module, to transmit location and transaction data to a remote server for additional verification. This remote server can then send back a confirmation or fraud alert based on the remote server's own analysis. In yet another embodiment, the user interface may provide additional features such as a map showing the locations of both the electronic device and the ATM, or options for the user to override the fraud warning if they believe the fraud warning to be a false positive. The system can be further enhanced with machine learning algorithms that improve fraud detection accuracy over time by learning from past transaction data.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
obtaining, with a communication device or one or more sensors of the electronic device, identifying information about another electronic device from an object situated within an environment of the electronic device;
determining, with a location detector of the electronic device, a location of the electronic device;
determining, with one or more processors of the electronic device from the identifying information about the another electronic device, whether the location of the electronic device is proximately located with the another electronic device; and
where the one or more processors fail to determine that the another electronic device is proximately located with the electronic device, presenting, by the one or more processors on a user interface of the electronic device, a prompt comprising a fraud warning.

2. The method of claim 1, wherein:
the object comprises a quick response (QR) code attached to or presented by an automated teller machine (ATM) situated within the environment of the electronic device; and
the obtaining the identifying information comprises scanning, with an image capture device of the electronic device, the QR code.

3. The method of claim 2, wherein the one or more processors determine that the another electronic device is proximately located with the electronic device when the another electronic device is the ATM.

4. The method of claim 2, wherein the determining whether the another electronic device is proximately located with the electronic device comprises determining whether the another electronic device is within a predefined distance threshold from the electronic device.

5. The method of claim 4, further comprising obtaining, by the communication device from a remote electronic device across a network using the identifying information, a location of the another electronic device.

6. The method of claim 5, wherein the determining whether the another electronic device is proximately located with the electronic device is performed locally on the electronic device by the one or more processors.

7. The method of claim 4, further comprising transmitting, with the communication device, the location of the electronic device and the identifying information to a remote electronic device across a network.

8. The method of claim 7, wherein the determining whether the another electronic device is proximately located with the electronic device comprises receiving, with the communication device, electronic communication signals identifying whether the another electronic device is proximately located with the electronic device.

9. The method of claim 4, wherein the prompt comprises a user actuation target allowing an authorized user of the electronic device to override the prompt.

10. The method of claim 2, wherein the determining the location of the electronic device occurs concurrently with the obtaining the identifying information.

11. The method of claim 10, further comprising detecting, by the one or more processors, an initiation of a financial transaction using the ATM, wherein the prompt comprises a user actuation target allowing the financial transaction to be aborted.

12. An electronic device, comprising:
an location detector;
one or more sensors;
one or more processors operable with the location detector and the one or more sensors; and
a user interface operable with the one or more processors;
wherein the one or more processors present a prompt on the user interface indicating that a financial transaction, initiated with a first remote electronic device situated beyond a predefined threshold from a location determined by the location detector but identified by information the one or more sensors obtained from a second remote electronic device situated within an environment of the electronic device, should be aborted.

13. The electronic device of claim 12, wherein the first remote electronic device and the second remote electronic device both comprise automated teller machines (ATMs).

14. The electronic device of claim 13, wherein the information is presented in a quick response (QR) code scanned by the one or more sensors from a surface or a display of the second remote electronic device.

15. The electronic device of claim 14, wherein the prompt comprises a user actuation target allowing an authorized user of the electronic device to override the prompt.

16. The electronic device of claim 15, wherein the one or more processors further cause the user interface to present a map identifying both the location of the electronic device and another location of the first remote electronic device.

17. A method in an electronic device, the method comprising:
scanning, with an image capture device, a quick reference (QR) code from an automated teller machine (ATM) situated within an environment of the electronic device;
determining, with one or more processors, whether the QR code identifies an ATM location that is proximately located with a location of the electronic device determined by a location detector carried by the electronic device; and
where the one or more processors fail to determine that the ATM location is proximately located with the location of the electronic device determined by the location detector, presenting, by the one or more processors, a prompt on a user interface of the electronic device allowing a financial transaction initiated by the one or more processors with the ATM to be aborted.

18. The method of claim 17, wherein the determining whether the ATM location is proximately located with the location of the electronic device determined by the location detector comprises:
transmitting, with a communication device, the location of the electronic device determined by the location detector and information extracted from the QR code to a remote electronic device across a network; and
receiving, with the communication device, a determination whether the ATM location is proximately located with the location of the electronic device determined by the location detector.

19. The method of claim 17, wherein the determining whether the ATM location is proximately located with the location of the electronic device determined by the location detector comprises:
transmitting, with a communication device, information extracted from the QR code to a remote electronic device across a network; and
receiving, with the communication device, location information from the remote electronic device; and
comparing, with the one or more processors, the location information received from the remote electronic device to the location of the electronic device determined by the location detector.

20. The method of claim 17, wherein the ATM location is proximately located with the location of the electronic device determined by the location detector when a distance between the ATM location and the location of the electronic device determined by the location detector is less than a predefined distance threshold.
